(19) United States
(12) Patent Application Publication
(10) Pub. No.: US 2025/0214488 A1
(43) Pub. Date: Jul. 3, 2025

(54) VEHICLE SEAT RUNNER

(71) Applicant: Faurecia Sièges d'Automobile, Nanterre (FR)

(72) Inventors: Emmanuel LEMEE, CALIGNY (FR); Samuel GROSSET, CALIGNY (FR); François CHERON, VERSON (FR)

(21) Appl. No.: 19/004,324

(22) Filed: Dec. 29, 2024

(30) Foreign Application Priority Data
Dec. 27, 2023 (FR) FR 2315385

(51) Int. Cl. B60N 2/07

(52) U.S. Cl. CPC B60N 2/0705; B60N 2/0732

(57) ABSTRACT

A vehicle seat runner that includes: a fixed profile, extending in a longitudinal direction; a movable profile, slidably mounted in the longitudinal direction on the fixed profile, having an upper wall bordered by two wings, each wing having an inner surface facing the upper wall and an outer surface opposite the inner surface in a transverse direction; and a bracket extending in an elevation direction, welded to the movable profile. The bracket is attached to the movable profile by at least one weld point formed between a receiving portion of the seat and the movable profile from an upper edge of a contact portion, on the side of an inner surface of the contact portion.

### TECHNICAL FIELD

The present invention relates to a vehicle seat runner and a method for manufacturing such a runner.

More particularly, the invention relates to a vehicle seat runner comprising:
a fixed profile, intended to be attached to a floor of the vehicle and extending in a longitudinal direction,
a movable profile, slidably mounted on the fixed profile in the longitudinal direction, the movable profile having an upper wall extending in the longitudinal direction bordered by two wings extending below the upper wall in an elevation direction perpendicular to the longitudinal direction,
at least one bracket extending in the elevation direction, welded to the movable profile.

### BACKGROUND

In the technical field of vehicle seats, it is known to mount the seat on one or more runners, for example to allow the seat to slide forwards and backwards relative to the chassis, in particular to a floor of the vehicle, for example for the purposes of postural comfort for the user.

To this end, each runner comprises a fixed profile on the floor of the vehicle and a movable profile, slidably mounted on the fixed profile.

The frame of the seat is mounted on brackets attached to the movable profiles.

A bracket attached to the movable profile may further be provided for each seat equipment, at least part of which must be able to slide with the seat, for example a seatbelt buckle.

In all cases, the bracket may be subjected to considerable mechanical stress. It is therefore particularly important that the attachment of the bracket to the movable profile is of sufficiently high and reproducible quality.

To this end, the connection between the bracket and the movable profile is often made by means of welds, particularly welds made with filler material.

However, the shape of the bracket and/or the movable profile generally makes the weld zone difficult to access, which complicates the attachment of the bracket to the profile. In addition, the welds are likely to generate “spatter”, that is, fragments of material may be projected towards the wings of the movable profile and/or towards the fixed profile and impair the subsequent operation of the runner connection and the service life thereof.

By way of example, in the case where the two profiles form a ball bearing runner, this spatter can, for example, reach the balls or the rails in which these balls slide and modify the surfaces of these elements, which are normally pre-polished, or inserted between these elements. It is therefore understood that subsequent sliding will not be optimal.

### SUMMARY

One of the aims of the invention is then to propose a motor vehicle seat runner whose bracket is welded to the movable profile in a simple, reliable and reproducible way and whose service life is improved.

To this end, the invention relates to a vehicle seat runner comprising:
a) a fixed profile, intended to be attached to a floor of the vehicle and extending in a longitudinal direction,
b) a movable profile, slidably mounted on the fixed profile in the longitudinal direction, the movable profile having an upper wall extending in the longitudinal direction bordered by two wings extending below the upper wall towards the fixed profile in an elevation direction perpendicular to the longitudinal direction, each wing comprising an inner surface facing the upper wall and an outer surface opposite the inner surface in a transverse direction substantially perpendicular to the longitudinal direction and to the elevation direction,
c) at least one bracket extending in the elevation direction, welded to the movable profile, and comprising i) a contact portion comprising an inner surface, placed in contact with at least a portion of the outer surface of one of the wings of the movable profile, and ii) a portion for receiving a seat frame or a seat equipment, the receiving portion extending above an upper edge of the contact portion in the elevation direction, at least part of the receiving portion extending above the upper wall in the elevation direction,
the bracket being attached to the movable profile by at least one weld point formed between the receiving portion and the movable profile from the upper edge of the contact portion on the side of the inner surface of the contact portion.

The positioning of the inner surface of the contact portion of the bracket along the outer surface of the respective wing allows a ridge corresponding to the upper edge of the inner surface to be formed in the runner. This ridge is bordered on the one hand by the elements of the movable profile that are found above the upper edge, therefore at least the upper wall and optionally a fraction of the respective wing, and on the other hand by the receiving portion, these two edges forming, in the vicinity of the ridge, a right angle or a projecting angle therebetween.

Access by the welding machine at the edge is easier from outside the bracket and the movable profile.

The weld between the bracket and the wing can therefore be formed in a simple, reproducible and robust manner.

In addition, the edges of the ridge form surfaces protecting against spatter. Any projection of material caused during welding are blocked by the receiving portion and/or by the upper wall and/or by the respective wing, so that these projections do not impact the elements forming the runner connection between the fixed profile and the movable profile.

The runner therefore has improved operation and a longer service life.

According to other advantageous aspects of the invention, the runner comprises one or more of the following features, taken alone or in all technically feasible combinations:
the bracket comprises a bearing portion extending in the transverse direction from the contact portion and/or from the receiving portion, the bearing portion being positioned above the upper wall in the elevation direction and in contact with at least a portion of the upper wall, the bearing portion comprising at least one through-opening giving access to at least part of the upper edge of the inner surface of the contact portion from outside the runner;
the runner comprises at least one additional weld point formed between the bearing portion and the upper wall above the upper wall;
a cross-section of the receiving portion of the bracket, taken in a transverse plane, is selected from a straight cross-section, an L-shaped cross-section and a U-shaped cross-section;
the runner comprises a plurality of weld points formed between the receiving portion and the movable profile from the upper edge of the inner surface of the contact portion, the weld points being distributed along the upper edge in the longitudinal direction;
the runner comprises a plurality of brackets, the brackets being spaced apart in the longitudinal direction.
the runner comprises at least two brackets, each wing bearing at least one of the brackets.

The invention also relates to a method for mounting a vehicle seat runner comprising:
a) providing:
   i) a fixed profile intended to be attached to a floor of the vehicle and extending in a longitudinal direction;
   ii) a movable profile, intended to be slidably mounted on the fixed profile in the longitudinal direction, the movable profile having an upper wall extending in the longitudinal direction bordered by two wings extending below the upper wall towards the fixed profile in an elevation direction perpendicular to the longitudinal direction;
   iii) at least one bracket extending in the elevation direction, said bracket comprising:
      a contact portion, an inner surface of which is delimited by an upper edge and configured to be placed in contact with at least a portion of an outer surface of one of the wings of the movable profile, said outer surface being found on the opposite side of the upper wall with respect to this wing in a transverse direction orthogonal to the longitudinal and elevation directions, opposite an inner surface of the wing facing the upper wall, and
      a receiving portion for a frame of the seat or seat equipment, the receiving portion extending above the upper edge of the contact portion in the elevation direction;
b) positioning the inner surface of the contact portion in contact with at least a portion of the outer surface of the respective wing;
c) forming at least one weld point from the upper edge between the receiving portion and the movable profile;
d) attaching the fixed profile to a floor of a vehicle;
e) assembling the movable profile with the fixed profile in a sliding manner in the longitudinal direction.

In a further advantageous aspect of the invention, the formation of the at least one weld point comprises providing a filler material.

### BRIEF DESCRIPTION OF THE DRAWINGS

The invention will become clearer on reading the following description, given solely by way of non-limiting example, and made with reference to the drawings, wherein:

FIG. 1 is a schematic representation of a side view of a vehicle seat;

FIG. 2 is a cross-sectional view in a transverse plane (YZ) of a first embodiment of a runner according to the invention;

FIG. 3 is an enlarged view of FIG. 2 at the weld point;

FIG. 4 is a three-dimensional view of a second embodiment of a runner according to the invention;

FIG. 5 is a view of the bracket of the runner of FIG. 3 alone, in a cross-sectional view in a transverse plane (YZ);

FIG. 6 is a cross-sectional view in a transverse plane (YZ) of a third embodiment of a runner according to the invention;

FIG. 7 is an enlarged view of FIG. 6 at the weld point;

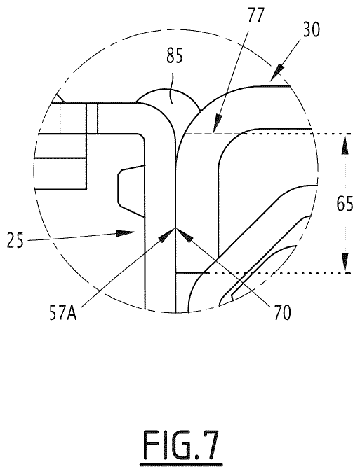

FIG. 8 is a three-dimensional view of a portion of a fourth embodiment of a runner according to the invention;

FIG. 9 is a cross-sectional view in a transverse plane (YZ) of the runner of FIG. 8; and

FIG. 10 is an enlarged view of FIG. 9 at the weld point.

### DETAILED DESCRIPTION

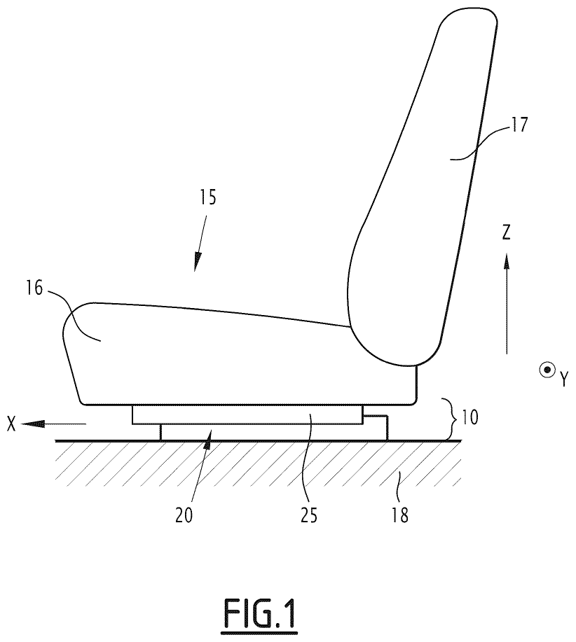

Referring to FIG. 1, a runner 10 of a vehicle seat 15 is described hereafter.

The vehicle (not shown) is for example a motor vehicle, but the runner 10 according to the invention may be used for seats in other types of vehicle, for example marine or aircraft vehicles.

The seat 15 in FIG. 1 very schematically comprises a seat base 16 and a backrest 17.

The seat base 16 is slidably mounted in a longitudinal direction X on a floor 18 of the vehicle by means of one or more runners 10. For a seat facing the front of the vehicle, the longitudinal direction X corresponds for example to the front-to-rear direction of the vehicle.

In a particular embodiment, the seat base 16 is connected to the chassis 18 via two parallel runners 10 in the longitudinal direction X.

Each runner 10 comprises a fixed profile 20, and a movable profile 25, slidably mounted on the fixed profile 20 in the longitudinal direction X and to which the seat base 16 is attached by means of at least one bracket 30 welded to the movable profile 25.

The fixed profile 20 is intended to be attached, notably fixed, to the floor 18 of the vehicle.

The fixed profile 20 extends in the longitudinal direction X.

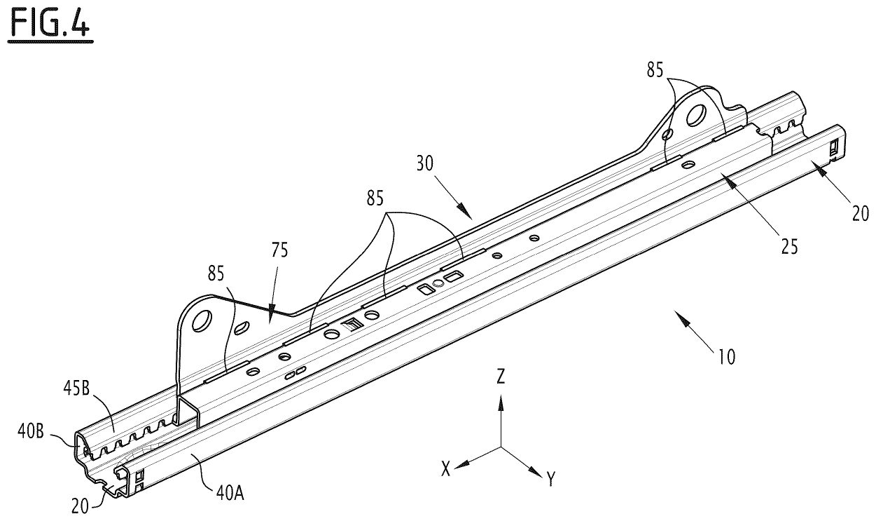

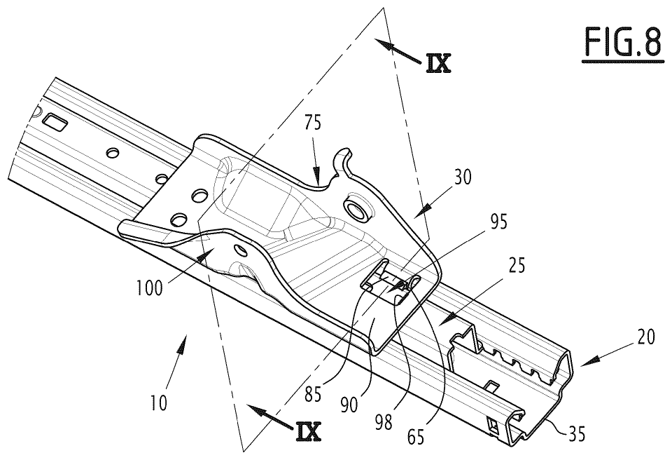

In a particular embodiment shown in greater detail in FIGS. 4 and 8, the fixed profile 20 is in the form of a female profile made from sheet metal bent and cut into a substantially U-shape.

In this case, the fixed profile 20 comprises a base 35 extending in the longitudinal direction X and a transverse direction Y for attachment to the floor 18, from which two side walls 40A, 40B extend substantially orthogonally to the base 35 in an elevation direction Z. When the runner is attached to the floor of the vehicle, the transverse direction Y corresponds for example to the vehicle width direction for a seat facing the front of the vehicle and the elevation direction Z corresponds to the vehicle height direction.

Two re-entrant troughs 45A, 45B of the fixed profile 20 extend the side walls 40A, 40B towards the inside of the runner 10 and towards the base 35.

The fixed profile 20 thus forms a female profile inside which the movable profile 25 is nested and slidably mounted in the longitudinal direction X.

In the examples shown, the movable profile 25 is in the form of a male profile made of bent and cut sheet metal, substantially in the shape of an inverted U.

The movable profile 25 comprises an upper wall 50 which extends in the longitudinal direction X and in the transverse direction Y, and two wings 55A, 55B which extend substantially orthogonally to the base 35 in the elevation direction Z towards the fixed profile 20, therefore below the upper wall 50 when the runner is attached to the floor of the vehicle.

Each wing 55A, 55B is delimited by a respective inner surface 56A, 56B facing the upper wall in the transverse direction Y and a respective outer surface 57A, 57B opposite, therefore facing away from the inverted U. Thus, the inner surfaces 56A, 56B extend opposite each other in the transverse direction Y and face the inside of the U.

The wings 55A, 55B are extended outwardly from the inverted U by a respective flap 60A, 60B.

Each of the flaps 60A, 60B is inserted into a space formed between the respective side wall 40A, 40B and the respective re-entrant trough 45A, 45B of the fixed profile 20, so as to ensure the runner connection between the fixed profile 20 and the movable profile 25.

Rolling elements (not shown), for example balls, are advantageously interposed between the flaps 60A, 60B and the side walls 40A, 40B, and/or between the flaps 60A, 60B and the re-entrant troughs 45A, 45B to ensure the sliding of the movable profile 25 on the fixed profile 20.

At least one bracket 30 is welded to the movable profile 25 to provide the connection between the seat base 16 and the movable profile 25 or to receive seat equipment to be moved with the seat base 16.

Thus, advantageously, one or more of the runners 10 on which the seat base 16 is mounted may comprise one or more additional brackets 30, each configured to receive one or more pieces of seat equipment, for example a fastening buckle for a seatbelt, raising rods, sensor and connector supports, etc.

Each bracket 30 extends in the elevation direction Z and comprises a contact portion 65 an inner surface 70 of which is placed in contact with at least a portion of the outer surface 57A, 57B of the wing 55A, 55B with which it is welded.

The bracket 30 also comprises a receiving portion 75 for a frame of the seat 15 and/or seat equipment extending from an upper edge 77 of the contact portion 65 in the elevation direction Z, on the opposite side to the fixed profile 20. In other words, the receiving portion 75 extends above the contact portion 65 and protrudes from the upper wall 50 of the movable profile 25 in the elevation direction Z.

The receiving portion 75 thus forms a male part, configured to engage with a corresponding female part comprised in the frame of the seat 15 and/or the respective seat equipment, or an attachment surface of the frame of the seat and/or the respective seat equipment.

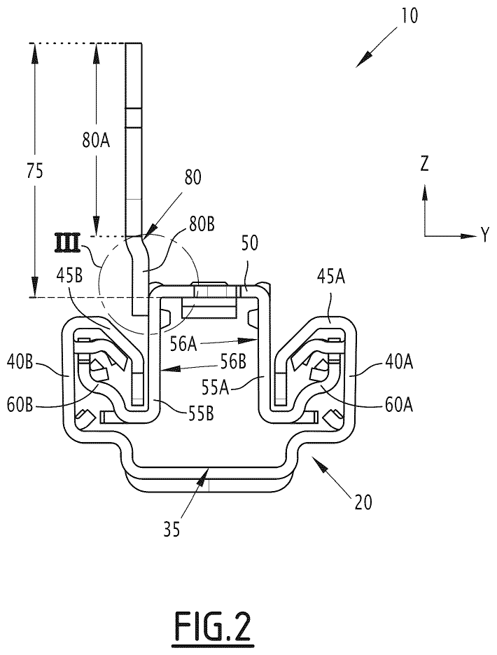

In the embodiment shown in FIG. 2, the cross-section of the receiving portion 75 of the bracket 30 in a transverse plane, that is, in a plane YZ orthogonal to the longitudinal direction X, is substantially straight.

Advantageously, the cross-section of the receiving portion 75 of the bracket 30 has, as shown in FIG. 2, a protuberance 80 between two straight portions 80A and 80B, the straight portions 80A and 80B then being more or less offset with respect to each other in the transverse direction Y. This arrangement allows the bracket 30 to engage with a female part offset with respect to the upper wall 50 in the transverse direction Y.

The bracket 30 is welded to the movable profile 25 by at least one weld point 85 formed between the receiving portion 75 and the movable profile 25 from the upper edge 77 of the contact portion 65, on the side of the inner surface 70 of the contact portion.

The weld point 85 can be formed by laser welding or by filler material, notably MAG (Metal Active Gas), CMT (Cold Metal Transfer), etc.

The number, positions and/or surface area of the weld points 85 are advantageously selected based on the shape of the receiving portion 75 and/or the type of seat or equipment with which the receiving portion 75 is intended to engage.

A weld point 85 is advantageously positioned at least at one end of the bracket 30 in the longitudinal direction X.

One or more additional weld points 85 are advantageously positioned at a distance from the ends of the bracket 30 in the longitudinal direction X.

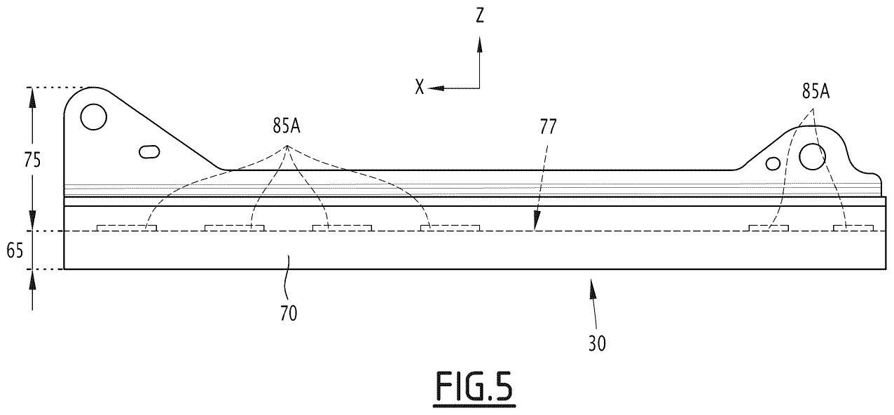

In the example shown in FIG. 4, six weld points 85 each extending substantially in the longitudinal direction X have been distributed in the longitudinal direction X, at six weld zones 85A of the bracket 30 shown in FIG. 5 and extending above the upper edge 77.

In a particular embodiment, weld points 85 are formed along the entire length of the upper edge 77.

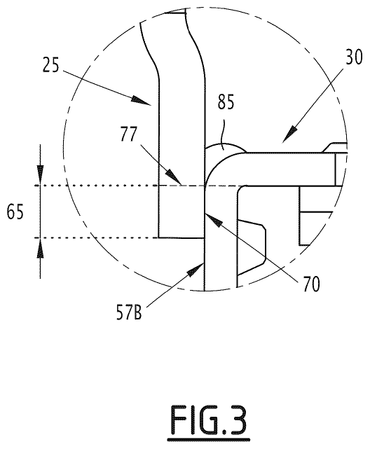

In the example shown in FIGS. 2 and 3, the weld point 85 extends between the receiving portion 75 and the respective wing 55B. It also extends above the upper wall 50.

Alternatively, the weld point 85 does not extend above the upper wall 50.

The procedure for mounting the runner 10 comprises the following steps:

In a supply step, a fixed profile 20, a movable profile 25 intended to be slidably mounted in the longitudinal direction X on the fixed profile 20 and at least one bracket 30 are provided.

In a positioning step, the inner surface 70 of the contact portion 65 is positioned in contact with the outer surface 57A, 57B of a respective wing 55A, 55B.

In a welding step, while maintaining this contact tightly, the weld point or points 85 are formed from the upper edge 77 between the receiving portion 75 and the movable profile 25 by means of a welding machine, for example laser or by filler material.

In an attachment step, the fixed profile 20 is attached to the floor 18.

Advantageously, the attachment step is the step immediately following the supply step.

In an assembly step, the movable profile 25, intended for being slidable in the longitudinal direction X, is mounted on the fixed profile 20.

Advantageously, the assembly step is the step that immediately follows the attachment step and precedes the positioning step.

Below the upper edge 77 in the elevation direction Z, the contact portion 65 and the respective wing 55A, 55B form a protection against projected spatter. Above the upper edge 77 in the elevation direction Z, the receiving portion 75 and the upper wall 50 also form a protection against projected spatter. As a result, the risk of such projections, more particularly in the case where the weld point 85 is formed with a filler material, is considerably reduced with respect to other weld point positions envisaged in the prior art.

The various elements that ensure the runner connection, in particular the flaps 45A, 45B, 60A, 60B and any rolling elements, are therefore protected from such spatter.

In addition, access to the weld zone 85A for forming the weld point 85 is easy, since only the receiving portion 75 and the upper wall 50 limit this access and form an angle greater than or equal to 90°. On the contrary, when the weld points are placed under the inverted U of the movable profile 25 as in the prior art, access to the weld zone is much more difficult as it is limited by the two wings of the inverted U.

The runner 10 according to the invention is therefore easy to manufacture, reproducible and has a high weld quality.

If, as shown in FIG. 2, the cross-section of the receiving portion 75 of the bracket 30 has a protuberance 80 between two straight portions 80A and 80B, the protuberance 80 further facilitates access to the weld zone 85.

As access to the weld zone 85A is easy, the welding step may be the last step in the mounting method without impacting the correct operation of the runner 10.

For the same reasons, an additional bracket 30 can easily be added to a runner 10 already mounted on the floor 18.

In this case, the additional bracket 30 may be on the same wing 55A, 55B as the first bracket 30 but offset in the longitudinal direction X.

The first bracket 30 and at least one additional bracket 30 may also each be positioned on a wing 55A, 55B.

Finally, the bracket 30 may be adapted to any movable profile 25 provided that it has a suitable inner contact surface 70, in particular without the need to machine holes in the movable profile 25.

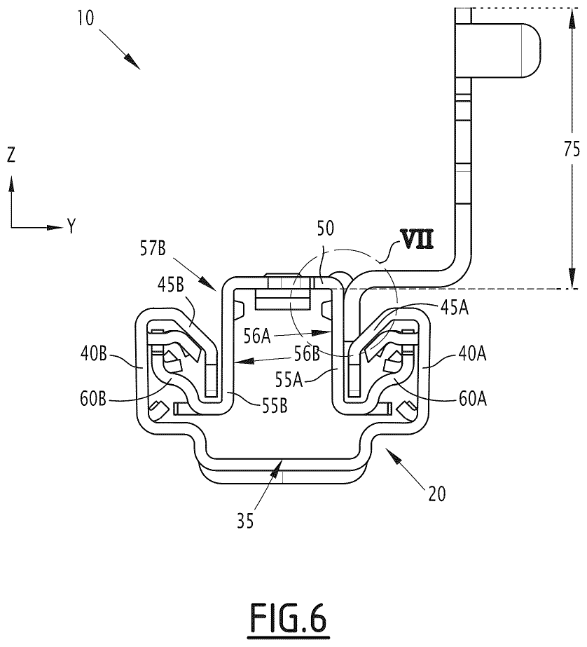

Alternatively, as shown in FIG. 6, the cross-section of the receiving portion 75 of the bracket 30 in a plane YZ orthogonal to the longitudinal direction X is L-shaped.

This arrangement allows the female portion intended to engage with the bracket 30 to be positioned at a greater distance from the movable profile 25 in the transverse direction Y.

As a result, access to the zone where the at least one weld point is formed is even easier. Assembling the runner 10 is therefore all the easier and all the more reproducible.

Advantageously, a bracket 30 is positioned on each wing 55A, 55B.

In this case, the two brackets 30 are advantageously positioned face to face, so that the upper wall 50 and the receiving portions 75 form an assembly for attaching a frame of the seat 15 and/or equipment of the seat 15 to the movable profile 25 whose cross-section in a plane YZ orthogonal to the longitudinal direction X is substantially U-shaped.

This arrangement allows the frame of the seat 15 and/or equipment of the seat 15 to be attached more securely than with a single bracket having a straight or L-shaped profile, without however requiring as much material as with a bracket whose receiving portion would have a U-shaped profile as will be described later.

Optionally, the bracket 30 comprises a bearing portion 90 which extends in the transverse direction Y from the contact portion 65 and/or the receiving portion 75.

The bearing portion 90 is positioned above the upper wall 50 in the elevation direction Z, in contact with at least a portion of the upper wall 50.

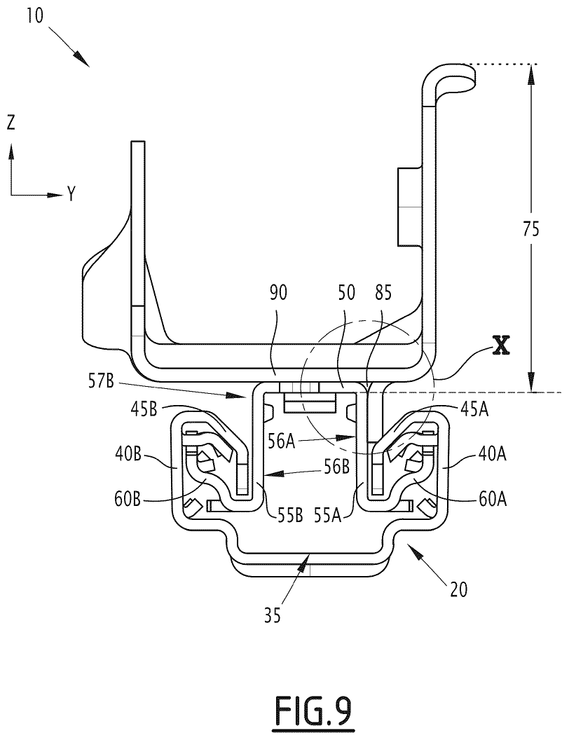

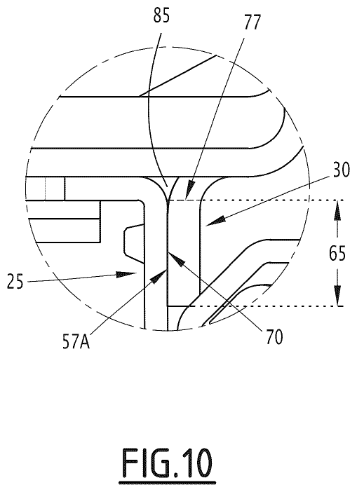

In the example shown in FIGS. 8 to 10, the bearing portion 90 extends only from the receiving portion 75.

In these examples, the bearing portion 90 is in contact with the upper wall 50 over the entire width thereof in the transverse direction Y.

The bearing portion 90 comprises at least one through-opening 95 providing access to at least part of the upper edge 77 of the inner surface 70 of the contact portion 65 from outside the runner 10.

In the example, the through-opening 95 has a square cross-section in the longitudinal plane XY, for example horizontal when the runner is attached to a vehicle floor resting on a horizontal ground. Other forms may also be envisaged.

Advantageously, the through-opening 95 extends over a length of the order of that of a respective weld zone 85A in the longitudinal direction X.

This arrangement allows the weld point or points 85 to be produced in the same way as described previously.

The bearing portion 90 facilitates the positioning of the bracket 30 on the movable profile 25. It also provides additional force transfer to the movable profile 25. These advantages are achieved without significantly restricting access to the weld zone 85A, thanks to the through-opening 95. The service life of the runner 10 is thus improved.

Advantageously, at least one additional weld point 98 is formed between the bearing portion 90 and the upper wall 50 above the upper wall 50.

The weld point is for example formed at an edge of the through-opening 95 which is not above the upper edge 77.

Advantageously, as shown in FIGS. 8 to 10, an attachment wing 100 extends from the bearing portion 90, opposite the receiving portion 75 in the transverse direction Y. The bearing portion 90, the receiving portion 75 of the bracket 30 and the attachment wing 100 thus form a bracket for attaching a frame of the seat 15 and/or equipment of the seat 15, the cross-section of which in a plane YZ orthogonal to the longitudinal direction X is substantially U-shaped.

This arrangement makes it possible to attach the frame of the seat 15 and/or equipment of the seat 15 just as securely as with two brackets 30 placed face-to-face as described hereinbefore, but with simpler and therefore quicker mounting.

1. A vehicle seat runner comprising:
a) a fixed profile, intended to be attached to a floor of the vehicle and extending in a longitudinal direction,
b) a movable profile, slidably mounted on the fixed profile in the longitudinal direction, the movable profile having an upper wall extending in the longitudinal direction bordered by two wings extending below the upper wall towards the fixed profile in an elevation direction perpendicular to the longitudinal direction, each wing comprising an inner surface facing the upper wall and an outer surface opposite the inner surface in a transverse direction substantially perpendicular to the longitudinal direction and to the elevation direction,
c) at least one bracket extending in the elevation direction, welded to the movable profile, and comprising:
i) a contact portion comprising an inner surface, placed in contact with at least a portion of the outer surface of one of the wings of the movable profile, and
ii) a receiving portion for a seat frame or equipment of a seat, the receiving portion extending above an upper edge of the contact portion in the elevation direction, at least part of the receiving portion extending above the upper wall in the elevation direction,
the bracket being attached to the movable profile by at least one weld point formed between the receiving portion and the movable profile from the upper edge of the contact portion on the side of the inner surface of the contact portion.

2. The runner according to claim 1, wherein the bracket comprises a bearing portion extending in the transverse direction from the contact portion and/or from the receiving portion, the bearing portion being placed above the upper wall in the elevation direction and in contact with at least a portion of the upper wall, the bearing portion comprising at least one through-opening giving access to at least part of the upper edge of the inner surface of the contact portion from outside the runner.

3. The runner according to claim 2, wherein at least one additional weld point is formed between the bearing portion and the upper wall above the upper wall.

4. The runner according to claim 1, wherein a cross-section of the receiving portion of the bracket, taken in a transverse plane, is selected from a straight cross-section, an L-shaped cross-section and a U-shaped cross-section.

5. The runner according to claim 1, comprising a plurality of weld points formed between the receiving portion and the movable profile from the upper edge of the inner surface of the contact portion, the weld points being distributed along the upper edge in the longitudinal direction.

6. The runner according to claim 1, comprising a plurality of brackets, the brackets being spaced apart in the longitudinal direction.

7. The runner according to claim 1, comprising at least two brackets, each wing bearing at least one of the brackets.

8. A method for mounting a vehicle seat runner comprising:
a) providing:
i) a fixed profile intended to be attached to a floor of the vehicle and extending in a longitudinal direction;
ii) a movable profile intended to be slidably mounted on the fixed profile in the longitudinal direction, the movable profile having an upper wall extending in the longitudinal direction bordered by two wings extending below the upper wall towards the fixed profile in an elevation direction perpendicular to the longitudinal direction;
iii) at least one bracket extending in the elevation direction, said bracket comprising:
a contact portion, an inner surface of which is delimited by an upper edge and configured to be placed in contact with at least a portion of an outer surface of one of the wings of the movable profile, said outer surface being positioned on the opposite side of the upper wall with respect to this wing in a transverse direction orthogonal to the longitudinal and elevation directions, opposite an inner surface of the wing facing the upper wall, and
a receiving portion for a frame of the seat or equipment of the seat, the receiving portion extending above the upper edge of the contact portion in the elevation direction;
b) positioning the inner surface of the contact portion in contact with at least a portion of the outer surface of the respective wing;
c) forming at least one weld point from the upper edge between the receiving portion and the movable profile;
d) attaching the fixed profile to a floor of a vehicle; and
e) assembling the movable profile with the fixed profile in a sliding manner in the longitudinal direction.

9. A mounting method according to claim 8, wherein the formation of the at least one weld point comprises providing a filler material.
